(19) United States
(12) Patent Application Publication
(10) Pub. No.: US 2017/0373305 A1
(43) Pub. Date: Dec. 28, 2017

(54) POROUS CARBON-METAL/ALLOY COMPOSITE MATERIAL, SYNTHESIS METHOD, AND ELECTRODE INCLUDING SAME

(71) Applicant: Sharp Kabushiki Kaisha, Osaka (JP)

(72) Inventors: Paul ADAMSON, Oxford (GB); Emma KENDRICK, North Warnborough (GB)

(21) Appl. No.: 15/189,337

(22) Filed: Jun. 22, 2016

(51) Int. Cl. H01M 4/36; H01M 4/133; H01M 10/0525; H01M 4/583; H01M 4/38; H01M 4/134; C04B 38/04; H01M 4/02

(52) U.S. Cl. CPC H01M 4/364; H01M 4/134; H01M 4/133; C04B 38/04; H01M 10/0525; H01M 4/583; H01M 4/387; C04B 2235/786; C04B 2235/785; H01M 2004/027

(57) ABSTRACT

A porous carbon-metal/alloy composite material includes a composition represented by (1−a)Sn₁₋ₓM¹ₓ+aM²+cC, wherein: M¹ includes one or more transition metals, metals, or metalloids; M² includes one or more transition metals, metals, or metalloids; x is 0≦x≦1; a is 0≦a≦1; and c is 0<c≦99. A method of forming the porous carbon-metal/alloy composite material includes the steps of dissolving one or more metal salts and a metal salt of polysaccharide to form a mixture; subjecting the mixture to heat treatment under an inert atmosphere to form carbon-metal/alloy composite material and metal salt by-product; and washing the formed carbon-metal/alloy composite material and the metal salt by-product with washing solvent to remove the metal salt by-product and obtain the porous carbon-metal/alloy composite material.

### TECHNICAL FIELD

This disclosure relates to a porous carbon-metal/alloy composite material, and a method of preparing the porous carbon-metal/alloy composite material. The present disclosure also relates to an electrode including the porous carbon-metal/alloy composite material for a metal ion battery that stores electrical energy and provides electrical energy.

### BACKGROUND ART

Metal-ion cells are a family of rechargeable cell types which are capable of storing and providing energy. In its most basic form, a metal-ion cell comprises an anode (negative electrode), a cathode (positive electrode) and an electrolyte material. This may be considered as a “cell unit”. A “cell stack” consists of multiple cell units stacked vertically and/or horizontally. Multiple cell units or multiple cell stacks may be used in conjunction to form a battery.

The most widespread example of a metal-ion battery is the lithium ion battery. Lithium-ion batteries are widely used in consumer electronic devices and are also growing in popularity in other applications such as electric vehicles. Metal-ion batteries all have the same basic structure and charge and discharge via a similar reaction mechanism. For example, when a lithium-ion battery is charging, Li⁺ ions deintercalate from the cathode and insert into the anode. Meanwhile charge balancing electrons pass from the cathode through the external circuit containing the charger and into the anode of the battery. During discharge, the same process occurs but in the opposite direction with the external circuit able to power a load. Sodium-ion batteries are analogous in many ways to the lithium-ion batteries that are in common use today, but instead a sodium ion Na⁺ shuttles between the cathode and anode in place of the lithium ions Li⁺. Lithium is not a cheap metal to source and is often considered too expensive for use in large scale applications. By contrast, sodium-ion battery technology is still in its relative infancy but is seen as potentially advantageous; sodium is much more abundant than lithium and some researchers predict this will provide a cheaper and more durable way to store energy into the future, particularly for large scale applications such as storing energy on the electrical grid.

The parts of the electrode which the metal ions either intercalate into, alloy with, hold onto the surface of, and/or hold within the pores of are referred to as an active material in the battery. In contrast, other components may be present, for example, as a substrate to support the active material, as a conductive additive, to bind the electrode components together, and/or to promote adhesion or flexibility.

There is a general drive to increase the energy density of the active materials in metal-ion batteries. A greater storage capacity in the active material may allow, for example, a smaller battery size in a device and/or extra energy available to the device being powered or for a greater battery life between charges. In addition to battery capacity, the cycle life of a battery is also an important factor, with many applications demanding hundreds or in some cases thousands of cycles with only a small fraction of the initial capacity becoming unusable. Approaches which can increase the energy density of metal-ion batteries are to develop high voltage cathode active materials or to develop high capacity anode and cathode active materials.

The energy density of an electrochemical cell can be specified either in Wh/Kg for the gravimetric energy density or in Wh/I for the volumetric energy density. The performance of the active materials contained in the anode or cathode can be characterised by a specific charge or discharge capacity, usually referred to just as “specific capacity,” which again may be either a specific gravimetric capacity or a specific volumetric capacity (mAh/g, mAh/cm³). An ideal anode active material has a high specific capacity and a low electrochemical potential. The lower electrochemical potential allows for a higher voltage available to the external circuit when the anode is placed against a cathode material within a battery cell, and the higher specific capacity allows for the intercalation or alloying of more of the metal ions.

The most popular anode for room temperature lithium-ion batteries is graphite. The positive features of graphite are a flat and low working potential versus lithium, however the intercalation of lithium into graphite is limited to only one lithium ion for every six carbon atoms, 6C+Li⁺+e⁻→LiC₆ with a resulting reversible capacity of 372 mAhg⁻¹. For sodium-ion batteries, the larger sodium ions cause exfoliation of the graphite anode, and therefore other forms of carbon such as hard carbon (also known as amorphous carbon) or expanded graphite oxide are often used. These hard carbon or expanded graphite oxide materials have a specific capacity of approximately 250-300 mAhg⁻¹ with an average voltage of approximately 0.2V vs Na. To achieve high cycling efficiency and long cycle life, the movement of sodium ions into and out of the cathode and anode active materials should not change or damage the crystal structure.

Other potential electrode material such as metal oxides or metal alloys, which intercalate or alloy with sodium, have large theoretical capacities and may provide an increased specific capacity and hence an increased energy density of the cell. But one practical problem with these materials is the large volume changes which accompany the alloying of the metal ions (e.g., Na⁺) with the metal or metal alloy anode. This causes pulverization of the metal or metal alloy particles and rapid capacity fade of the battery cells.

Efforts have been made to reduce the extent of this pulverization. For example, the use of nanostructured electrodes may provide room for this expansion and reduce the extent of pulverization, thereby increasing the cycle life, and have been studied for lithium ion and sodium ion batteries. The use of nanocomposites as anode materials in metal-ion batteries has also been studied, for example tin-graphite or silicon-graphite composites. Also described in the literature is the use of a carbon matrix with higher capacity anode active material particles, wherein the presence of a conductive carbon matrix can absorb the large volume changes during cycling, with an improved cycle life reported for increasing carbon content. In some examples, a liquid anode has been used in an electrochemical cell to try to mitigate the issues concerning the pulverization of the metal or metal alloy material during cycling.

International Application Publication No. WO2014141732A1 (Zhu et al., published Sep. 18, 2014) describes a tin-metal complex and a method of producing the same. The complex comprises a carbon sheet-like matrix and tin nanoparticles in the sheet-like matrix. The Sn nanoparticles range in diameter from 0.2 to 5 nm and particles with a diameter greater than 1 um are not contained. The invention provides a synthesis method that uses a cationic polymer and sulphuric acid. The use of the invention as a negative electrode in a non-aqueous lithium ion battery is described.

Chinese Patent Application No. CN104577075A (Li et al., published Apr. 29, 2015) discloses a graphitized mesoporous carbon/tin composite negative electrode material for lithium ion batteries. The nanotin is embedded in the pore walls of the mesoporous carbon. This invention describes a synthesis route involving a solid-liquid grinding template method. Vegetable oil is the carbon precursor; hydrated tin chloride is the tin source and mesoporous silicon oxide is a template. The silicon oxide is chemically removed after a heat treatment step.

U.S. Pat. No. 8,945,431B2 (Schultz et al., published Feb. 3, 2015) describes a process for producing electrically conductive, porous, silicon- and/or tin-containing carbon materials. The use of these materials as anodes in lithium ion batteries is also described. In the synthesis method provide silicon and/or tin nanoparticles are dispersed in at least one organic polymer and the polymer is carbonized in a heat treatment step.

United States Patent Application Publication No. US2014/0170491A1 (Chen et al., published Jun. 19, 2014) provides a composition that includes mesoporous carbon domains, incorporated with particles of metal or metal oxide. The metal is at least one of tin, cobalt, copper, molybdenum, nickel, iron, or ruthenium (or oxide). The use of a composition in a battery electrode which has a specific capacity of more than 1000 mAh/g after 15 cycles is described.

International Application Publication No. WO2014081786A1 (Obrovac et al., published May 30, 2014) describes an anode for sodium ion batteries. The anode includes an electrochemically active phase and an electrochemically inactive phase that share at least one common phase boundary. The electrochemically active phase is essentially free of crystalline grains greater than 40 nm.

U.S. Pat. No. 8,765,862B2 (Matsumura et al., published Jul. 1, 2014) describes a composite which comprises a matrix resin layer in which metal nanoparticles are immobilized. A method of producing the metal nanoparticles is provided. The metal nanoparticles are in the range 1-100 nm. The metal nanoparticles are formed by metals from gold (Au), silver (Ag), copper (Cu), palladium (Pd), platinum (Pt), tin (Sn), rhodium (Rh), and iridium (Ir).

Bresser et al., “Embedding tin nanoparticles in micron-sized disordered carbon for lithium- and sodium-ion anodes” (Electrochimica Acta 128 (2014) 163-171) describe a method of making a tin-carbon nanocomposite. This synthesis involves mixing together Sn acetate and sugar before heating at high temperature.

### SUMMARY OF INVENTION

In accordance with one aspect of the present disclosure, a porous carbon-metal/alloy composite material includes a composition represented by Chemical Formula (1):

(1−a)Sn₁₋ₓM¹ₓ+aM²+cC (1)

wherein: M¹ includes one or more transition metals, metals, or metalloids; M² includes one or more transition metals, metals, or metalloids; x is 0≦x≦1; a is 0≦a≦1; and c is 0<c≦99, wherein the carbonaceous component (C) is a macroporous material and the metal/alloy component (1−a)Sn₁₋ₓM¹ₓ+aM² is embodied as particles dispersed in the macroporous carbonaceous component (C).

In some embodiments, M¹ is chromium, titanium, vanadium, iron, manganese, cobalt, nickel, copper, zinc, gallium, indium, silicon, germanium, or antimony.

In some embodiments, M² is chromium, titanium, vanadium, iron, manganese, cobalt, nickel, copper, zinc, gallium, indium, silicon, germanium, or antimony.

In some embodiments, M¹ is the same material as M². In some embodiments, M¹ is a different material than M².

In some embodiments, a is 0. In some embodiments, a is 1.

In some embodiments, one or both of M¹ and M² includes more than one component.

In some embodiments, the metal/alloy component particles are spherical particles.

In some embodiments, the average size of the metal/alloy component particles is 5 nm to 500 nm.

In some embodiments, the porous carbonaceous component (C) is embodied as porous matrix particles. In some embodiments, the average size of the matrix particles is 1 μm-150 μm.

In accordance with another aspect of the present disclosure, an electrode includes the porous carbon-metal/alloy composite material.

In accordance with another aspect of the present disclosure, a metal-ion cell includes: an anode including the porous carbon-metal/alloy composite material; a cathode; and a separator including an ionically conducting electrolyte medium.

In accordance with another aspect of the present disclosure, a method of forming a porous carbon-metal/alloy composite material including a composition represented by Chemical Formula (1):

(1−a)Sn₁₋ₓM¹ₓ+aM²+cC (1)

wherein: M¹ includes one or more transition metals, metals, or metalloids; M² includes one or more transition metals, metals, or metalloids; x is 0≦x≦1; a is 0≦a≦1; and c is 1<c≦99, the method including: mixing one or more metal salts and a metal salt of polysaccharide to form a mixture; subjecting the mixture to heat treatment under a non-oxidizing atmosphere to form a carbon-metal/alloy composite material and a metal salt by-product; and washing the formed carbon-metal/alloy composite material and the metal salt by-product with a washing solvent to remove the metal salt by-product and obtain the porous carbon-metal/alloy composite material.

In some embodiments, the carbonaceous component (C) is a macroporous material and the metal/alloy component (1−a)Sn₁₋ₓM¹ₓ+aM² is embodied as particles dispersed in the macroporous porous carbonaceous component (C).

In some embodiments, the metal salt and metal salt of polysaccharide are mixed to form the mixture without addition of a solvent.

In some embodiments the metal salt and metal salt of the polysaccharide are mixed to form the mixture in the presence of a solvent. In some embodiments, the method further includes heating the mixture to drive off any liquid from the mixture prior to subjecting the mixture to the heat treatment.

In some embodiments, the method further includes drying the obtained porous carbon-metal/alloy composite material.

In some embodiments, the method further includes subjecting the porous carbon-metal/alloy composite material to an additional heat treatment.

In some embodiments, the method further includes grinding the obtained porous carbon-metal/alloy composite material.

In some embodiments, the porous carbonaceous component (C) is embodied as porous matrix particles. In some embodiments, the average size of the matrix particles is 1 μm-150 μm.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

FIG. 1 is a flow chart showing an exemplary synthesis method for producing the porous carbon-metal/alloy composite material of the present disclosure.

FIG. 2 are X-ray powder diffraction patterns from Example 1 of a porous carbon-metal/alloy composite material of the present disclosure collected before and after the heat treatment under an inert atmosphere.

FIG. 3 is a scanning electron microscopy (SEM) image from Example 1 (corresponding to sample 11 in Table 1) of Sn-porous carbon composite after heating to 800° C. under flowing nitrogen. 20.0 μm scale bar shown.

FIG. 4 is another SEM image from Example 1 (corresponding to sample 11 in Table 1) of Sn-porous carbon composite after heating to 800° C. under flowing nitrogen. 500 nm scale bar shown.

FIG. 5 is another SEM image from Example 1 (corresponding to sample 11 in Table 1) of Sn-porous carbon composite after heating to 800° C. under flowing nitrogen. 30 μm scale bar is shown. The numbers shown in the micrograph are the dimensions of the pore openings in μm.

FIG. 6 are X-ray powder diffraction patterns from Example 2 (corresponding to sample 2 in Table 1) of a porous carbon-metal/alloy composite material of the present disclosure collected before and after washing a Ni—Sn heat-treated material with water.

FIG. 7 is a schematic illustration of a metal-ion electrochemical cell containing the porous carbon-metal/alloy of the present disclosure.

### DETAILED DESCRIPTION OF INVENTION

Hereinafter, the embodiments of the present disclosure will be described with reference to the accompanying tables and figures.

In the following description, an active material describes a component of an electrode (e.g., a cathode or an anode) which contributes to the capacity of the electrode. The cathode is the positive electrode of the cell and the anode is the negative electrode of the cell. An active component refers to a component of an electrode which is electrochemically active and therefore either inserts, hosts, alloys with, and/or mixes with the metal ions which are moving between the cathode and anode.

### Porous Carbon-Metal/Alloy Composite Material

The porous carbon-metal/alloy composite material of the present disclosure may be represented by Chemical Formula (1):

(1−a)Sn₁₋ₓM¹ₓ+aM²+cC (1)

wherein:

M¹ includes one or more transition metals, metals, or metalloids;

M² includes one or more transition metals, metals, or metalloids;

x is 0≦x≦1;

a is 0≦a≦1; and

c is 0<c≦99.

Hence, Chemical Formula (1) represents a composite material including a metal/alloy component (1−a)Sn₁₋ₓM¹ₓ+aM², and a porous carbonaceous component cC.

The letters a and x represent the stoichiometry of the material constituents. In some embodiments, the value of a and x may be an integer (i.e., a whole number). In other embodiments, the value of one or more of a and x may be a non-integer (i.e., a fraction).

In some embodiments, a is 0. Accordingly, in some embodiments, (1−a)Sn₁₋ₓM¹ₓ may be the only metal/alloy component in the composite material. In other embodiments, a is 1. Accordingly, in some embodiments, aM² may be the only metal/alloy component in the composite material. In other embodiments, a may be a value other than 0 or 1 such that both (1−a)Sn₁₋ₓM¹ₓ and aM² may be present in the composite material. In some examples the value of a is in the range of 0≦a<1. In other examples the value of a, is in the range of 0≦a≦0.25. In other examples, the value of a is in the range of 0.25≦a≦0.5. In other examples, the value of a is in the range of 0.5≦a≦0.75. In other examples, the value of a is in the range of 0.75≦a≦1.

In some examples the value of x, representing the amount of M¹ in (1−a)Sn₁₋ₓM¹ₓ is in the range of 0≦x≦0.25. In other examples, the value of x is in the range of 0.25≦a≦0.5. In other examples, the value of x is in the range of 0.5≦a≦0.75. In other examples, the value of x is in the range of 0.75≦a≦1.

In some examples the value of c, representing the amount of C is in the range of 0<c≦25. In other examples, the value of c is in the range of 25≦c≦50. In other examples, the value of c is in the range of 50≦c≦75. In other examples, the value of c is in the range of 75≦c≦99.

In some embodiments, M¹ may be the same material as M². Accordingly, in some embodiments, M¹ and M² in Chemical Formula (1) may both be generally represented as M. In other embodiments, M¹ may be a different material than M².

In some embodiments, M¹ includes one or more transition metals, metals, or metalloids. Exemplary transition metals include titanium, vanadium, chromium, manganese, iron, cobalt, nickel, copper, yttrium, zirconium, niobium, molybdenum, rhodium, palladium, silver, cadmium, hafnium, tantalum, tungsten, osmium, platinum, and gold. Exemplary metals and metalloids include magnesium, zinc, calcium, beryllium, strontium, barium, aluminium, gallium, indium, silicon, germanium, antimony and boron. In some embodiments, M¹ is selected from chromium, titanium, vanadium, iron, manganese, cobalt, nickel, copper, zinc, gallium, indium, silicon, germanium or antimony. In some embodiments, M¹ includes a single material. In other embodiments, M¹ includes more than one component. For example, M¹ may be a binary material or a ternary material.

In some embodiments, M² includes one or more transition metals, metals, or metalloids. Exemplary transition metals include titanium, vanadium, chromium, manganese, iron, cobalt, nickel, copper, yttrium, zirconium, niobium, molybdenum, rhodium, palladium, silver, cadmium, hafnium, tantalum, tungsten, osmium, platinum, and gold. Exemplary metals and metalloids include magnesium, zinc, calcium, beryllium, strontium, barium, aluminium, gallium, indium, silicon, germanium, antimony and boron. In some embodiments, M² is selected from chromium, titanium, vanadium, iron, manganese, cobalt, nickel, copper, zinc, gallium, indium, silicon, germanium or antimony. In some embodiments, M² includes a single material. In other embodiments, M² includes more than one component. For example, M² may be a binary material or a ternary material.

The porous carbon-metal/alloy composite material may have one or more distinct properties. For example, the porous carbon-metal/alloy composite material may contain a metal and/or alloy capable of alloying with alkali metals.

The metal/alloy may form discrete particles which on average are under 500 nm in diameter. The particles may be contained in a carbonaceous matrix and may be dispersed throughout the carbonaceous matrix.

The porous carbon-metal/alloy composite material may include a porous carbonaceous support matrix and metal/alloy particles dispersed through the support matrix.

In some embodiments, the carbonaceous support matrix may be embodied as one or more porous matrix particles. The term “matrix particle” as used herein refers to a porous carbonaceous component of the composite which hosts the metal/alloy component and may or may not also be active. The term “particle” as used herein is not intended to limit the scope of the present disclosure and, unless specified to the contrary, may include a solid of any size or shape. In some embodiments, the average size of the matrix particles may be about 1 μm to about 150 μm. In some embodiments, the carbonaceous component may be provided in one or more other forms (e.g., a sheet, film, or other suitable shape).

The carbonaceous support matrix (whether in particulate form or in another form) may be a macroporous material. It will be appreciated that in some embodiments the carbonaceous support matrix may also include mesopores and/or micropores. In accordance with the present disclosure, the following porosity types are defined as follows:
Microporous: pore diameters of less than 2 nm
Mesoporous: pore diameters 2 nm to 49 nm
Macroporous: pore diameters equal to or greater than 50 nm

Metal/alloy particles may be embedded in the carbonaceous support matrix. The metal/alloy may form discrete particles which may have an average size of about 500 nm or less in diameter. The particles may be spherical particles which have an average size of about 500 nm or less in diameter. In other embodiments, the particle may have another suitable non-spherical shape. The average size of the particles may also be greater than 5 nm in size/diameter.

In some embodiments, the porous carbon-metal/alloy material may be utilized as part of an electrode. The electrode may contain one or more of the composite materials described above, suitable for use in energy storage applications such as rechargeable batteries.

In some embodiments, the porous carbon-metal/alloy material may be utilized as part of an energy storage device that utilizes electrodes according to the present disclosure as described above. As an example, the energy storage device may be one or more of the following: a sodium and/or lithium and/or potassium ion cell; a sodium and/or lithium and/or potassium metal cell; a non-aqueous electrolyte sodium and/or potassium ion; an aqueous electrolyte sodium and/or lithium and/or potassium ion cell.

In some embodiments, a battery may include one or more of the metal/alloy composite materials of the present application, and particularly a sodium or lithium ion battery or other electrical storage device including grid connected electrical energy storage systems or devices.

In some embodiments, the porous carbon-metal/alloy material may be utilized as a catalyst for use in organic chemistry reactions. Exemplary catalytic reactions include, but are not limited to, hydrogenation reactions, cracking of petroleum derived compounds, Fischer-Tropsch synthesis, hydrodesulphurisation, and hydroformylation. The porous carbon-metal/alloy composite material of the present disclosure may be embodied as the active material in such catalytic reactions.

### Synthesis Method

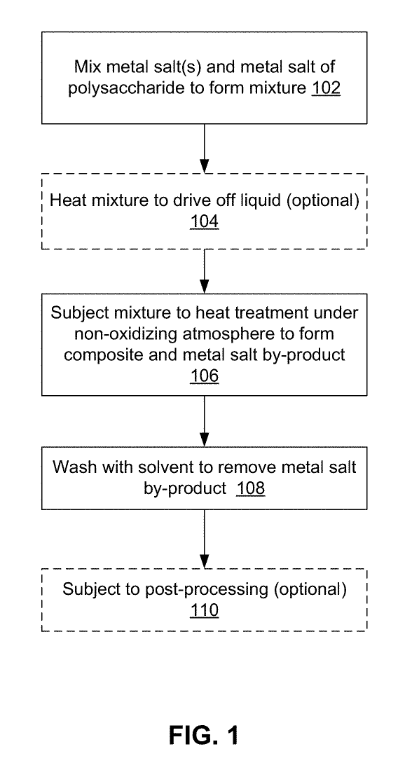

FIG. 1 is a flow chart showing an exemplary synthesis method for producing a porous carbon-metal/alloy composite material in accordance with the present disclosure. The produced composite material includes a porous carbonaceous support matrix and metal/alloy particles dispersed through the support matrix. The composite materials may be synthesised by the following method:

At step 102, one or more metal salts and metal salt of polysaccharide are mixed together to form a mixture. The mixing may be conducted via a blending and/or milling process. The blending and/or milling may be conducted for any suitable amount of time. In some embodiments, the mixture is blended and/or milled for 2 minutes to 14 days. In other embodiments, the mixture is blended and/or milled for 30 minutes to 12 hours. The metal salt(s) chosen for use depend largely on the types of metal/alloy component to be yielded. Exemplary metal salts include metal chlorides such as SnCl₂, CoCl₂, NiCl₂, CuCl₂. Other exemplary metal salts include sulfates, nitrates, phosphates, fluorides, borates, selenates, bromides, iodides, and the like. Exemplary metal salts of polysaccharide include metals such as sodium, lithium, calcium, magnesium, potassium, zinc and polysacharaides such as carboxymethyl cellulose, guar gum, locust bean gum, alginate or alginic acid, gluconate, pectin, and chitin.

In some embodiments, the mixing of the one or more metal salts and the metal salt of polysaccharide is conducted in the presence of a solvent. In such embodiments, the formed mixture may be in the form of a solution. In some embodiments, the solvent may be water. In other embodiments, alternative or additional solvents to water such as ethanol, ethylene glycol, methanol, isopropyl alcohol, ether, acetonitrile or hexanol may be used wholly or in part as the solvent. The solution may be stirred for 2 minutes to 12 hours. In other embodiments, the solution may be stirred for 30 minutes to 2 hours. In some embodiments, the mixing may be conducted at room temperature (e.g., at about 25° C.). In other embodiments, the mixing may be conducted at an elevated temperature (e.g., about 26° C. to about 80° C.). The elevated temperature may be lower than that of the boiling point of the solvent or may be under reflux conditions if higher than the boiling point of the solvent.

In other embodiments, the mixing of the one or more metal salts and the one or more metal salts of polysaccharide is conducted without a solvent. For example, the mixture may be formed by milling the one or more metal salts and the metal salt of polysaccharide.

Step 104 is an optional step that may be conducted, for example, if the mixing of the one or more metal salts and the one or more metal salts of polysaccharide is conducted in the presence of a solvent. In other embodiments, for example, where a solvent is not used in step 102, step 104 may be omitted. At step 104, the mixture is heated to drive off any liquid (e.g., the solvent) from the mixture prior to subjecting the mixture to the heat treatment. The heating may be conducted at a temperature above the boiling point of the solvent for a suitable time to effect evaporation. The heating may be conducted under reduced pressure. In some embodiments, the heating may be conducted at a temperature ranging from about 80° C. to about 200° C. In other embodiments, the heating may be conducted at a temperature ranging from about 100° C. to about 150° C. The specific temperature at which the heating is conducted may vary, so long as the temperature will effect evaporation of the solvent. In some embodiments, the heating may be conducted for a time period ranging from 2 minutes to 12 hours. In other embodiments, the heating may be conducted for a time period ranging from 30 minutes to 2 hours. The specific time for which the heating is conducted may vary depending on the type and/or amount of solvent, but will be conducted for a sufficient time to drive off the liquid.

At step 106, the mixture is subjected to heat treatment under a non-oxidizing atmosphere (e.g., in a nitrogen atmosphere, air purged, or reducing atmosphere) to form the desired composite in combination with a metal salt by-product. The metal salt-by-product may vary depending on the materials used in forming the mixture. As an example, in some embodiments where the one or more metal salts include one or more metal chlorides and the metal salt of polysaccharide includes sodium salt of polysaccharide, the metal salt by-product may be NaCl. In some embodiments, the atmosphere may be CO/CO2, CO2, H2/N2, H2, SO2, or Argon. In some embodiments, the mixture is heated to temperatures between 100° C. and 1300° C. for a period of time ranging from 5 minutes to 12 hours. In other embodiments, the mixture is heated to temperatures between 500° C. and 1300° C. for a period of time ranging from 5 minutes to 12 hours. The heat treatment step may reduce the components of the mixture to produce metal nanoparticles dispersed throughout a carbonaceous matrix. The nanoparticles may be greater than 5 nm in average size/diameter. The nanoparticles may also be less 500 nm in average size/diameter.

At step 108, the composite is washed with one or more washing solvents. The washing solvent removes the metal salt by-product from the composition, and the product of metal/alloy nanoparticles in a porous carbonaceous support matrix is obtained. This synthesis method produces a porous composite material. The porosity is achieved by the synthesis of the metal salt by-product (e.g., NaCl) which is washed out. As described above, the carbonaceous support matrix may be a macroporous material. In some embodiments, the washing solvent may be water. In other embodiments, alternative or additional solvents to water such as ethanol, ethylene glycol, methanol, isopropyl alcohol, ether, acetonitrile or hexanol may be used wholly or in part as the washing solvent.

Subsequently, at step 110 (optional), the porous composite material can be subjected to one or more post-processing steps. In one example, the porous composite material may be dried to remove any remaining solvent. In another example, the porous composite material may be subjected to an additional heat treatment. The additional heat treatment may be conducted at the same or at different conditions as compared with the heat treatment of step 106. In some embodiments, the additional heat treatment may be conducted between 500° C. and 1300° C. for a period of time ranging from 5 minutes to 12 hours. In another example, the porous composite material can be ground into a fine powder. As an example, the metal/alloy particles may be 10 nm-500 nm in average diameter and may be dispersed throughout the matrix particles which have been ground to 1 μm-150 μm in average size.

The porous carbon-metal/alloy composite material produced by the above method may have one or more benefits. Firstly, the metal/alloy particles and matrix particles are formed at the same time, resulting in an intimate mixture. Secondly, the metal/alloy particles are contained in the matrix particles which can buffer volume changes associated with (de)alloying with alkali metals. Thirdly, the formation of a second phase which is subsequently removed by washing introduces pores to the structure. Such pores result in shorter diffusion paths for ions. Fourthly, the matrix material is carbonaceous and may or may not be active depending on the reaction conditions. Fifthly, the small particle size of the metal/alloy allows alloying without pulverization resulting in enhanced cycle life. Sixthly, the addition of an organic acid to the reaction mixture may allow for control of the particle size and shape.

Using the above representative synthesis method, several exemplary materials were prepared. These exemplary materials are summarized in Table 1.

TABLE 1
Summary of exemplary porous carbon-metal/alloy composite materials
produced using the exemplary synthesis method of FIG. 1

| | | STARTING | | Furnace |
|---|---|---|---|---|
| Sample | TARGET | MATERIALS | Solvents | conditions |
| 1 | Sn/C | SnCl2 (0.008 mol) | 300 mL water | 800° C. |
| | | Na alginate (0.016 | | Flowing N2 |
| | | mol) | | |
| 2 | Ni3Sn4/C | SnCl2 (0.0034 mol) | 300 mL water | 800° C. |
| | | NiCl2 (0.0046 mol) | | Flowing N2 |
| | | Na alginate (0.016 | | |
| | | mol | | |
| 3 | Sn/C | SnCl2 (0.008 mol) | 300 mL water | 1100° C. |
| | | Na alginate (0.016 | | Flowing N2 |
| | | mol) | | |
| 4 | CoSn/C | SnCl2 (0.004 mol) | 300 mL water | 800° C. |
| | | CoCl2 (0.004 mol) | | Flowing N2 |
| | | Na alginate (0.016 | | |
| | | mol | | |
| 5 | Sn/C | SnCl2 (0.008 mol) | 300 mL water | 900° C. |
| | | Na alginate (0.016 | | Flowing N2 |
| | | mol) | | |
| 6 | Sn/C | SnCl2 (0.008 mol) | 300 mL water | 1000° C. |
| | | Na alginate (0.016 | | Flowing N2 |
| | | mol) | | |
| 7 | Sn/C | SnCl2 (0.008 mol) | 300 mL water | 1200° C. |
| | | Na alginate (0.016 | | Flowing N2 |
| | | mol) | | |
| 8 | Sn/C | SnCl2 (0.008 mol) | 300 mL water | 800° C. |
| | | Na alginate (0.016 | | Flowing N2 |
| | | mol) | | 1100° C. |
| | | | | Flowing N2 |
| 9 | Cu12Sn10/C | SnCl2 (0.0036 mol) | 300 mL water | 800° C. |
| | | CuCl2 (0.0044 mol) | | Flowing N2 |
| | | Na alginate (0.016 | | |
| | | mol | | |
| 10 | Sn/C | SnCl2 (0.008 mol) | 0 mL water | 800° C. |
| | | Na alginate (0.016 | | Flowing N2 |
| | | mol) | | |
| 11 | Sn/C | SnCl2 (0.008 mol) | 300 mL water | 800° C. |
| | | Na carboxymethyl | | Flowing N2 |
| | | cellulose (0.016 mol) | | |
| 12 | Sn/C | SnBr2 (0.008 mol) | 300 mL water | 800° C. |
| | | Na carboxymethyl | | Flowing N2 |
| | | cellulose (0.016 mol) | | |
| 13 | Sn/C | SnCl2 (0.008 mol) | 300 mL water | 800° C. |
| | | Potassium gluconate | | Flowing N2 |
| | | (0.016 mol) | | |
| 14 | Cu12Sn10/C | SnBr2 (0.0036 mol) | 300 mL water | 800° C. |
| | | CuBr2 (0.0044 mol) | | Flowing N2 |
| | | Na alginate (0.016 | | |
| | | mol | | |

### Exemplary Procedure to Make and Cycle a Sodium Metal Electrochemical Test Cell:

Electrochemical cells were prepared for use in connection with conventional electrochemical testing techniques.

Materials were tested as cast electrodes. To prepare an electrode of the test material, the sample was prepared using a solvent-casting technique, from a slurry containing the active material (e.g., the porous carbon-metal/alloy composite material), conductive carbon, binder and solvent. The conductive carbon used in the slurry was Super P C45 (Timcal). PAA (Sigma, UK) was used as the binder, and NMP (N-Methyl-2-pyrrolidone, Anhydrous, Sigma, UK) was used as the solvent. The slurry was then cast onto a carbon-coated aluminium current collector using the Doctor-blade technique. The electrode was then dried under Vacuum at about 80-120° C. for 2 hours to 12 hours. As formed, the electrode film contained the following components, expressed in percent by weight: 80% active material, 10% Super P carbon, and 10% PAA binder. Optionally, this ratio can be varied to optimize the electrode properties such as, adhesion, resistivity and porosity.

The electrolyte includes a 1.0 M solution of NaPF₆ in A 1:1 mixture of ethylene carbonate and diethylene carbonate with 5 wt % fluoroethylene carbonate as an additive, and can also be any suitable or known electrolyte or mixture thereof. A glass fibre separator (e.g. Whatman, GF/A) or a porous polypropylene separator (e.g. Celgard 2400) wetted by the electrolyte is interposed between the positive and negative electrodes forming the electrochemical test cell. Electrochemical cells of materials prepared according to the procedures outlined in Table 1 were tested using Constant Current Constant Voltage Cycling Techniques. Typically, cells were discharged galvanostatically at a rate of 30 mA/g followed by a constant voltage step which was maintained until current decayed to one tenth of its initial value. The cells were charge galvanostatically at a rate of 30 mA/g. The cells were cycled between pre-set voltage limits as deemed appropriate for the material under test, typically between 0.01 and 0.8 V. A commercial battery cycler from Maccor Inc. (Tulsa, Okla., USA) was used.

### Structural Characterisation:

All of the product materials were analysed by X-ray diffraction techniques using a Bruker D2 phaser powder diffractometer (fitted with a Lynxeye™ detector) to confirm that the desired target materials had been prepared, and also to establish the phase purity of the products and to determine the types of impurities present. From this information it is possible to determine the unit cell lattice parameters.

The operating conditions used to obtain the powder diffraction patterns illustrated, are as follows:

### Range: 2θ=10°-90°

### X-ray Wavelength=1.5418 Å (Angstoms) (Cu Kα)

Step size: 2θ=0.02
Speed: 1.5 seconds/step

### Example 1

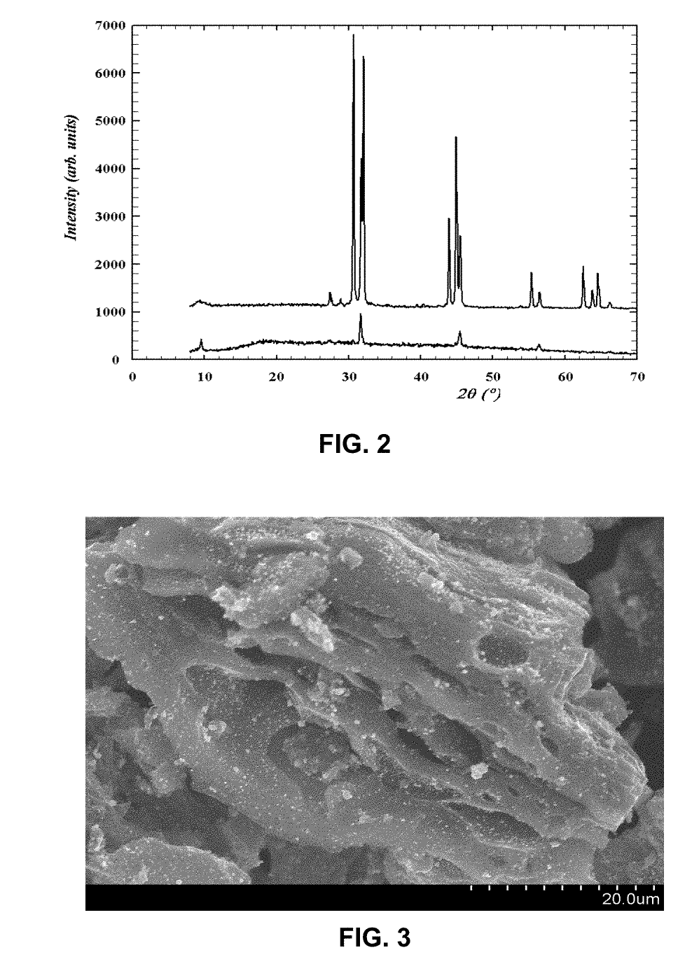

Example 1 is an example relating to sample 11 provided above in Table 1, and is an example of a Sn-carbon composite prepared using the above-described synthesis method. FIGS. 2-5 are figures relating to Example 1.

FIG. 2 shows X-ray powder diffraction patterns collected before and after the heat treatment under an inert atmosphere. Tin is the only metallic component in the target composition for this synthesis. The lower pattern was collected after the mixing and drying stage. The peaks at approximately 32, 46 and 56° 2theta are assigned to diffraction from NaCl crystallites. There are no peaks present that can be assigned to a Sn-containing material. The upper pattern was collected after a high temperature heat treatment under an inert atmosphere but before washing. The sharp peaks at approximately 30 32, 44, 45, 55, 62, 64 and 65° 2theta are assigned to diffraction from Sn crystallites. The peaks at approximately 32, 46 and 56° 2theta are assigned to diffraction from NaCl crystallites. The absence of any significant peaks at other positions provides evidence of the high purity of samples prepared using this method. Patterns were collected using a Bruker D2-phaser with Cu-Kα X-ray source.

FIG. 3 shows a scanning electron microscopy (SEM) image of Sn-porous carbon composite after heating to 800° C. under flowing nitrogen and subsequent washing. 20.0 μm scale bar shown. FIG. 3 demonstrates the general morphology of these materials. Large irregular shaped particles of carbon are evident and are typically <100 μm across. The pores formed by removal of the by-product are visible in this image.

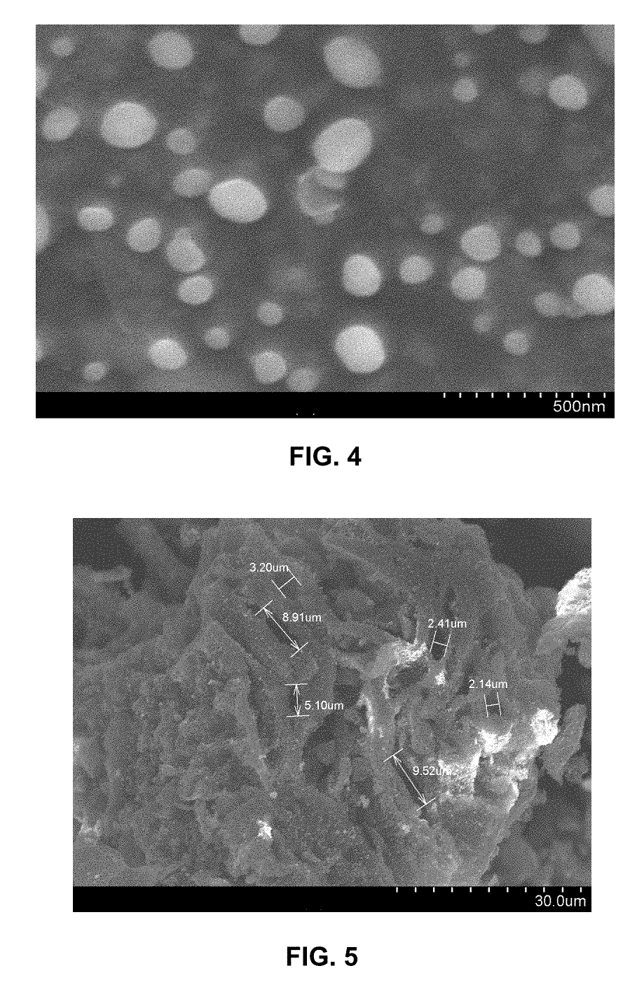

FIG. 4 shows another SEM image of Sn-porous carbon composite after heating to 800° C. under flowing nitrogen and subsequent washing. FIG. 4 shows one of these particles at a higher level of magnification. 500 nm scale bar shown. The surface of the carbon particle is decorated with particles of Sn, evident as light coloured areas in the micrograph. These particles are typically 100 nm or less in diameter. The Sn particles are also contained inside the carbon particle as evidenced by the light grey areas in the micrograph.

FIG. 5 shows another SEM image of Sn-porous carbon composite after heating to 800° C. under flowing nitrogen and subsequent washing. 30 μm scale bar is shown. The measurements shown on the micrograph are the dimensions of the pore openings in μm. These values are consistent with the material being macroporous.

### Example 2

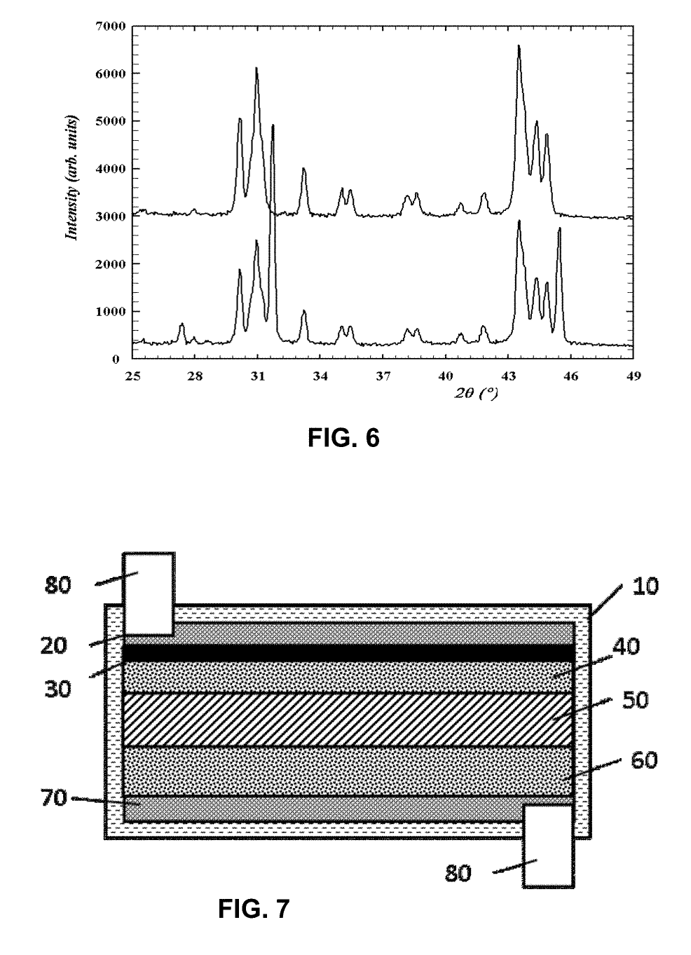

Example 2 is an example relating to sample 2 provided above in Table 1. Example 2 is the synthesis of a Sn—Ni alloy carbon composite prepared using the above-described synthesis method. FIG. 6 relates to Example 2.

FIG. 6 shows X-ray powder diffraction patterns collected before and after washing a Ni—Sn heat-treated material with water. The lower pattern was collected before washing and the peaks at approximately 32 and 46° 2theta are due to scattering from NaCl crystallites. All other peaks can be assigned to Ni—Sn alloys. The upper pattern was collected after washing and the peaks at 32 and 46° 2theta are no longer present which confirms NaCl has been removed by the washing process. Patterns were collected using a Bruker D2-phaser with Cu-Kα X-ray source.

### Exemplary Metal-Ion Cell

Embodiments of the present disclosure relate to a reversible metal-ion cell which incorporates an electrode including the porous carbon-metal/alloy composite material and which may be repeatedly charged and discharged, to store energy upon charge and produce energy during the discharge. The present disclosure is not particularly limited to a given battery format. The battery format for the present disclosure may include but is not limited to cylindrical cells, button cells, prismatic cells and pouch cells. In FIG. 7, the battery is shown as a pouch cell format. The electrode stack is contained within a laminated pouch material (10) which may prevent short circuit paths, may protect the cell components from reactions with air or moisture, and may contain the cell components within the package. Within the pouch cell (10) there is an electrode stack made of a plurality of anode and cathode layers.

As described in FIG. 7, the cell stack is comprised of an anode (40) including at least a porous carbon-metal/alloy composite of the present disclosure. The anode (40) may in addition contain additives for binding the components together and improvement in conduction, increasing conductivity, or other functions. The stack also contains a cathode (60) which incorporates a metal intercalation material, and an ionically conducting electrolyte medium and separator (50), which is sandwiched between the anode (40) and cathode (60). The anode (40) is supported by an anodic current collector (20) and the cathode (60) is supported by a cathodic current collector (70). The anodic current collector (20) may be coated with a protective layer (30). The cell stack is placed inside a container (10), which may be laminated aluminium, which may prevent short circuits and protects the cell from the air. The anode and cathode are connected to an external circuit via tabs (80) which remove and input the electrons into the cell.

The separator (50) may include a thin film which is soaked in a liquid electrolyte. The separator (50) may include a porous film, a non-woven fabric, and a woven fabric, and may be made of a material of a polyolefin resin such as polyethylene and polypropylene, a fluororesin, nylon, and an aromatic aramid can be used, or in some cases cellulosic fibres or material. The thickness of the separator (50) may be about 10 μm to 200 μm, and preferably 10 μm to 30 μm. The separator (50) may be a combination such that separators having differing porosities are laminated. The separator (50) may additionally contain a coating of ceramic, polyvinylidene fluoride (PVFD), a surfactant chemical or any combination thereof. Alternatively, the separator layer (50) may be a ceramic separator. This ceramic separator may for example contain ceramic particles blended with PVDF polymer or may be made by a different method. Alternatively, the separator layer (50) may be a polymer or gel electrolyte, such as polyethylene oxide (PEO), or a block or co polymer such as polyethylene oxide-co-propylene oxide) acrylate. In some embodiments the polymer may be plasticised with a solvent such as propylene carbonate, dimethyl sulfoxide, ethylene glycol, triethylamine, DMF (dimethylformamide), DMSO (dimethyl sulphoxide), polyethoxide ether, poly ethylene succinate, aprotic organic solvents.

The separator layer (50) in some embodiments also contains an electrolyte, the electrolyte material(s) may be any conventional or known material(s) and may comprise either aqueous electrolyte(s) or non-aqueous electrolyte(s) or mixtures thereof. The electrolyte medium may include at least one of an ionic liquid. Examples of solvents usable in the non-aqueous electrolyte of a sodium-ion or lithium-ion secondary battery of the present invention include carbonates such as propylene carbonate (PC), ethylene carbonate (EC), vinylene carbonate, dimethyl carbonate (DMC), diethyl carbonate, ethyl methyl carbonate, isopropyl methyl carbonate, 4-trifluoromethyl-1,3-dioxolan-2-one, and 1,2-di(methoxycarbonyloxy)ethane; ethers such as 1,2-dimethoxyethane, 1,3-dimethoxypropane, pentafluoro propyl methyl ether, 2,2,3,3-tetrafluoropropyl difluoromethyl ether, tetrahydrofuran, and 2-methyltetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, 1,3-propane sultone, ethylene sulfite, propylene sulfite, dimethyl sulfite, and diethyl sulfite; and those obtained by introducing a fluorine substituent into the above-described organic solvents. Usually, two or more kinds of these solvents are mixed and used. Among these, preferred is a mixed solvent containing carbonates, and more preferred is a mixed solvent of a cyclic carbonate and a non-cyclic carbonate or a mixed solvent of a cyclic carbonate and ethers. These electrolyte solvents advantageously contain an alkali metal conducting salt with a weakly bound cation such as perchlorate ClO4-, PF6-, triflate (CF₃SO₃)—, bis(oxalato) borate (BC₄O₈—, BOB) or imide/TFSI (N(SO₂CF₃)₂).

Ionic liquid electrolytes may be comprised of one or more of the following salts 1-ethyl-3-methylimidazolium bis(trifluoromethylsulfonyl)imide; 1-ethyl-3-methylimidazolium tetrafluoroborate; 1-butyl-3-methylimidazoliumbis(trifluoromethylsulfonyl)imide; 1-butyl-3-methylimidazolium tetrafluoroborate; 1-hexyl-3-methylimidazolium; bis(trifluoromethylsulfonyl)imide; 1-hexyl-3-methylimidazolium tetrafluoroborate; 1-butyl-2,3-dimethylimidazolium bis(trifluoromethylsulfonyl)imide; 1-butyl-2,3-dimethylimidazolium tetrafluoroborate; N-octylpyridinium tetrafluoroborate; N-butyl-4-methylpyridinium tetrafluoroborate; and N-butyl-4-methylpyridinium hexafluorophosphate. Ionic liquids included in electrolyte medium may comprise cations of the pyridine and pyrrollidinium group such as: methyl-1-propyl pyrrolidinium [MPPyrro]+, 1-methyl-1-butyl pyrrolidinium [MBPyrro]+, 1-methyl-1-propyl piperidinium [MPPip]+, 1-methyl-1-butyl piperidinium [MBPip]+, 1-methyl-1-octylpyrrolidinium [MOPyrro]+ and 1-methyl-1-octylpiperidinium [MOPip]+.

In some embodiments, the polymer separator film (50) may be replaced with an ionically conducting solid, glass or polymer. Solid electrolytes include garnets, nasicons, lisicons, beta alumina or other alkali metal ion conducting solid oxides or sulphide glasses or solids.

The cathode (60) typically includes a cathode active material, a conductive additive such as carbon black, carbon nanotubes, carbon fibres, tungsten carbide, and a polymeric binder such as PTFE, PVDF, CMC, EPDM, SBR, alginate, polyacrylic acid or PEO or any other appropriate polymeric binder material or mixture thereof.

Active material examples of the cathode (60) include layered oxides such as the lithium, sodium or mixed lithium and sodium transition metal oxides. Examples include P₂—NaₓCoO₂, P₂—Na_{2/3}[Nii_{/3}Mn_{2/3}]O₂, Na_{0.4}MnO₂, NaₓMO₂. Sodium transition metal phosphates or sulfates such as NaFePO₄, NaVPO₄F, Na₃V₂(PO4)2F3, Na₂FePO₄F, Na₃V₂(PO₄)3, Na2M2(SO4)3, Na2M(SO4)2, NaMSO4F and the organic cathode material P(EO)₈NaCF₃SO₃ (polyethylene oxide sodium trifluoromethanesulfonate), Where M is in part a redox active transition metal. Lithium cathode materials include, but not exclusively lithium cobaltate, lithium nickel manganese cobalt oxide, lithium iron phosphate, lithium transition metal sulfates and sulfate fluorides (LiFeSO4F, Li2Fe2(SO4)3) and lithium vanadium phosphate fluoride.

The cathode current collector (70) is typically an aluminium foil, or carbon coated aluminium foil for lithium and sodium ion batteries. In some cases, the current collector may be a carbon paper, or graphite foil.

The anode current collector (20) is typically copper foil for lithium cells whereas aluminium can be used as well in sodium ion examples. Other examples of current collector include carbon coated aluminium copper or aluminium foil or stainless steel foils. In some cases, the current collector may be a carbon paper or graphite foil.

### INDUSTRIAL APPLICABILITY

The invention relates to an improvement in metal-ion battery technology and may be applied for use in many different applications such as energy storage devices, rechargeable batteries and electrochemical devices. Advantageously the cells according to the invention may increase the capacity of the anode.

1. A porous carbon-metal/alloy composite material comprising a composition represented by Chemical Formula (1):
(1−a)Sn₁₋ₓM¹ₓ+aM²+cC (1)
wherein:
M¹ includes one or more transition metals, metals, or metalloids;
M² includes one or more transition metals, metals, or metalloids;
x is 0≦x≦1;
a is 0≦a≦1; and
c is 0<c≦99,
wherein the carbonaceous component (C) is a macroporous material and the metal/alloy component (1−a)Sn₁₋ₓM¹ₓ+aM² is embodied as particles dispersed in the macroporous carbonaceous component (C).

2. The porous carbon-metal/alloy composite material of claim 1, wherein M¹ is chromium, titanium, vanadium, iron, manganese, cobalt, nickel, copper, zinc, gallium, indium, silicon, germanium, or antimony.

3. The porous carbon-metal/alloy composite material of claim 1, wherein M² is chromium, titanium, vanadium, iron, manganese, cobalt, nickel, copper, zinc, gallium, indium, silicon, germanium, or antimony.

4. The porous carbon-metal/alloy composite material of claim 1, wherein M¹ is the same material as M².

5. The porous carbon-metal/alloy composite material of claim 1, wherein M¹ is a different material than M².

6. The porous carbon-metal/alloy composite material of claim 1, wherein a is 0.

7. The porous carbon-metal/alloy composite material of claim 1, wherein a is 1.

8. The porous carbon-metal/alloy composite material of claim 1, wherein one or both of M¹ and M² comprises more than one component.

9. The porous carbon-metal/alloy composite material of claim 1, wherein the metal/alloy component particles are spherical particles.

10. The porous carbon-metal/alloy composite material of claim 1, wherein average size of the metal/alloy component particles is 5 nm to 500 nm.

11. The porous carbon-metal/alloy composite material of claim 1, wherein the porous carbonaceous component (C) is embodied as porous matrix particles.

12. The porous carbon-metal/alloy composite material of claim 11, wherein the average size of the matrix particles is 1 μm-150 μm.

13. An electrode comprising the porous carbon-metal/alloy composite material of claim 1.

14. A metal-ion cell comprising:
an anode comprising the porous carbon-metal/alloy composite material of claim 1;
a cathode; and
a separator comprising an ionically conducting electrolyte medium.

15. A method of forming a porous carbon-metal/alloy composite material comprising a composition represented by Chemical Formula (1):
(1−a)Sn₁₋ₓM¹ₓ+aM²+cC (1)
wherein:
M¹ includes one or more transition metals, metals, or metalloids;
M² includes one or more transition metals, metals, or metalloids;
x is 0≦x≦1;
a is 0≦a≦1; and
c is 1<c≦99, the method comprising:
mixing one or more metal salts and a metal salt of polysaccharide in a solvent to form a mixture;
subjecting the mixture to heat treatment to form a carbon-metal/alloy composite material and a metal salt by-product; and
washing the formed carbon-metal/alloy composite material and the metal salt by-product with a washing solvent to remove the metal salt by-product and obtain the porous carbon-metal/alloy composite material.

16. The method of claim 15, wherein the carbonaceous component (C) is a macroporous material and the metal/alloy component (1−a)Sn₁₋ₓM¹ₓaM² is embodied as particles dispersed in the macroporous porous carbonaceous component (C)

17. The method of claim 15, wherein the one or more metal salts and the metal salt of polysaccharide are mixed to form the mixture without addition of a solvent.

18. The method of claim 15, wherein the one or more metal salts and the metal salt of polysaccharide are mixed to form the mixture in the presence of a solvent.

19. The method of claim 18, wherein the method further comprises heating the mixture to drive off any liquid from the mixture prior to subjecting the mixture to the heat treatment.

20. The method of claim 15, further comprising drying the obtained porous carbon-metal/alloy composite material.
